(19) United States
(12) Patent Application Publication
(10) Pub. No.: US 2025/0324018 A1
(43) Pub. Date: Oct. 16, 2025

(54) Outputting Video Conference Key Points Within A Virtual Background Image

(71) Applicant: Zoom Communications, Inc., San Jose, CA (US)

(72) Inventors: Xuedong David Huang, Yarrow Point, WA (US); Bo Ling, Saratoga, CA (US); Yuzong Liu, Bothell, WA (US); Alexander Waibel, Sammamish, WA (US)

(21) Appl. No.: 18/634,606

(22) Filed: Apr. 12, 2024

(51) Int. Cl. H04N 7/15; G06F 3/14; G06T 17/00; H04N 5/265

(52) U.S. Cl. CPC H04N 7/157; G06F 3/1454; G06T 17/00; H04N 5/265; H04N 7/152

(57) ABSTRACT

A virtual background image used with a video stream of a conference participant during a video conference is updated to visually represent one or more key points of the video conference. Generative artificial intelligence software associated with a conferencing system evaluates content of a video conference to determine one or more key points related to the video conference. The generative artificial intelligence software updates a virtual background image of a participant of the video conference to include one or more visual elements representing the one or more key points. The updated virtual background image is then output for use within a video stream of the participant during the video conference.

### FIELD

This disclosure generally relates to video conferencing, and, more specifically, to generating virtual background images during video conferences and outputting those generated virtual background images within applicable video conference participant video streams.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a conferencing system that generates virtual background images for use with participant video streams during video conferences.

FIG. 6 is a block diagram of examples of inputs and output of generative artificial intelligence software used for video conferences.

FIG. 7 is an illustration of examples of contextual preferences usable for generating a virtual background image for one or more participants of a video conference.

FIG. 8 is a block diagram of example functionality of generative artificial intelligence software used for video conferences.

FIG. 9 is an illustration of examples of graphical user interfaces (GUIs) associated with generating a virtual background image for a participant of a video conference.

FIG. 10 is an illustration of examples of GUIs associated with outputting video conference key points within a virtual background image for a participant of a video conference.

FIG. 11 is an illustration of examples of GUIs associated with generating a unified virtual background image for multiple participants of a video conference.

FIG. 12 is a flowchart of an example of a technique for generating a virtual background image during a video conference.

FIG. 13 is a flowchart of an example of a technique for outputting video conference key points within a virtual background image.

FIG. 14 is a flowchart of an example of a technique for generating a unified virtual background image for multiple video conference participants.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

Conventional conferencing software approaches, such as those facilitated using UCaaS and like software platforms, allow a conference participant to use a virtual background to replace an actual background of the conference participant within a video stream. To use a virtual background, object detection software detects the conference participant as a foreground portion of the video stream captured using the conference participant's camera. The conference participant is clipped out of each video frame of the video stream and combined onto the virtual background image to generate a composite image, which is then transmitted as a video frame of the video stream for rendering within a conferencing software user interface. Use of virtual backgrounds during video conferences is popular for security and privacy purposes, such as to prevent other conference participants from observing sensitive or private content that may be within the field of view of a camera used to capture a video stream for a participant.

Video conferencing services which allow for the use of virtual backgrounds require participants to either select an image to use as their virtual background from a set of options or upload an image to use as their virtual background from a local storage (e.g., in either case, via a client application used to connect to the video conference). The virtual background images of the set available for participant selection are produced long before a subject video conference begins and generally depict commonplace contents with neutral colors and tones so as to appeal to a widest range of participants. For example, the selectable virtual background images may depict clean office environments with minimal color variance and few decorative objects. Some participants may prefer these options as they are more likely to blend in should other participants also select from amongst them. Others may seek to stand out by using their own locally stored images as virtual backgrounds and may accordingly upload an image for such use.

However, conventional conferencing software approaches do not provide a convenient way for video conference participants to change their virtual backgrounds (or to start using virtual backgrounds, as the case may be) once a video conference is already in progress. Instead, a participant who wishes to change their virtual background (or begin using one) must navigate through a series of user interface menus, often disrupting their experience with the video conference (e.g., by losing focus on a current discussion or presentation). While many video conference participants may not want to make any changes to the appearance of their video stream once a video conference begins, some may revel in the opportunity to use a variety of virtual background images to change the appearance of their video stream one or more times throughout the video conference.

In particular, in one illustrative example, a participant may seek to change their virtual background to an image that is relevant to a current topic under conversation during the video conference or to an image representing something the participant wants to discuss. Despite this, participants who choose to change their virtual background or start using a virtual background during a video conference are limited to the same options as are described above. As such, a participant wishing to change their virtual background during a video conference may have to choose between a different image made generally available to all participants or a different image locally available at their device. In either case, the newly selected image is unlikely to be highly relevant to the video conference. Thus, to find a new virtual background image that is in fact relevant to the video conference, whether to a current or prospective topic of discussion therein, a participant today must focus their attention away from the video conference to browse the Internet for a fitting image. Accordingly, users of existing video conferencing software solutions who prefer to change their virtual backgrounds multiple times during a video conference may introduce substantial disruption to the video conference experience.

Implementations of this disclosure address problems such as these by using generative artificial intelligence to generate virtual background images based on input associated with a video conference. The generative artificial intelligence generally refers to software (i.e., generative artificial intelligence software) which has been trained to use an input to generate an image as output. The generative artificial intelligence software may be, include, or otherwise use one or more types of artificial intelligence or machine learning (collectively, AI/ML) models, for example, a generative pretrained transformer (GPT), a large language model (LLM), or a natural language processing (NLP) engine, a generative adversarial network (GAN), a variational autoencoder (VAE), or an autoregressive model (ARM). The generative artificial intelligence software may be trained using one or more commercially available training data sets to identify patterns across those data sets and to extrapolate from those patterns across other data. The generative artificial intelligence software may be trained via supervised or unsupervised learning.

The generative artificial intelligence software may be accessed and used during an in-progress video conference based on input obtained in connection with the video conference. In some cases, the input may correspond to text obtained via a text prompt within a GUI of the video conference or of a client application used to connect a participant device to the video conference. For example, a video conference participant may use a text prompt available within a GUI to input text representing an image that the participant wants to be generated (e.g., “a capitol building in a major city lit up at nighttime”). In some cases, the input may correspond to a conversation occurring during the video conference and captured within a real-time transcription of the video conference. For example, the real-time transcription may include speech content from one or more video conference participants independent of inputs directly provided within a GUI (e.g., “the most important thing is for the box to be green”). In some cases, the input may correspond to media previously generated by the same or different generative artificial intelligence software (e.g., an image generated based on lyrics within music generated by generative artificial intelligence and output during the video conference). A virtual background image generated according to the implementations of this disclosure may be a still image, a moving image, or a video comprising a sequence of images.

The implementations of this disclosure describe various use cases for using generative artificial intelligence to generate virtual background images based on input associated with a video conference. In some implementations, use cases include generating a virtual background image for a participant of a video conference based on input associated with the participant, in which the virtual background image is output for use within a video stream of the participant during the video conference. For example, information associated with a participant (e.g., an input obtained from their device) or with the video conference (e.g., an input derived from a real-time transcription) may be used by generative artificial intelligence software to dynamically generate and assert a virtual background for an individual participant of the video conference. One or more contextual preferences associated with the participant and/or the video conference may be used to limit or otherwise define the types of imagery which may be generated by the generative artificial intelligence software. In this way, user privacy may be protected while still enabling the use (e.g., via manual or automated means) of the generative artificial intelligence software for generating virtual background images.

In some implementations, use cases include updating a virtual background image of a participant of a video conference to include one or more visual elements representative of content of the video conference and outputting the updated virtual background image for use within a video stream of the participant during the video conference. For example, generative artificial intelligence software may evaluate content of the video conference to determine one or more key points related to the video conference. The generative artificial intelligence software may then update the virtual background image of the participant to include one or more visual elements representing the one or more key points. The key points may, for example, correspond to agenda items of the video conference, topic names or summaries manually input or derived via software (e.g., determined based on a real-time transcription of the video conference or extracted via computer vision from a slideshow presentation or blackboard visible within a video stream of the video conference), or the like. The updated virtual background image may thus represent some or all contents of the original version of the virtual background image but with the one or more key points visually arranged about one or more regions thereof.

In some implementations, use cases include generating a virtual background image for multiple participants (e.g., some or all participants) of a video conference based on input associated with the video conference, in which the virtual background image is output for use within multiple participant video streams during the video conference. For example, the virtual background image may be generated as a unified background to assert against all participant video streams of the video conference or against a subset of such participant video streams (e.g., all audience participants or all presenting participants). In some such cases, the video conference may be a webinar or a portion thereof and the virtual background image may be generated for participant use during the webinar. The virtual background image may be generated and asserted to create an immersive virtual environment for participants. In some cases, the virtual background image may be generated based on media previously generated for the video conference (e.g., using generative artificial intelligence software), such as based on music or other sounds generated for and output during the video conference.

As described throughout this disclosure, the implementations hereof may include or otherwise use one or more AI/ML systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

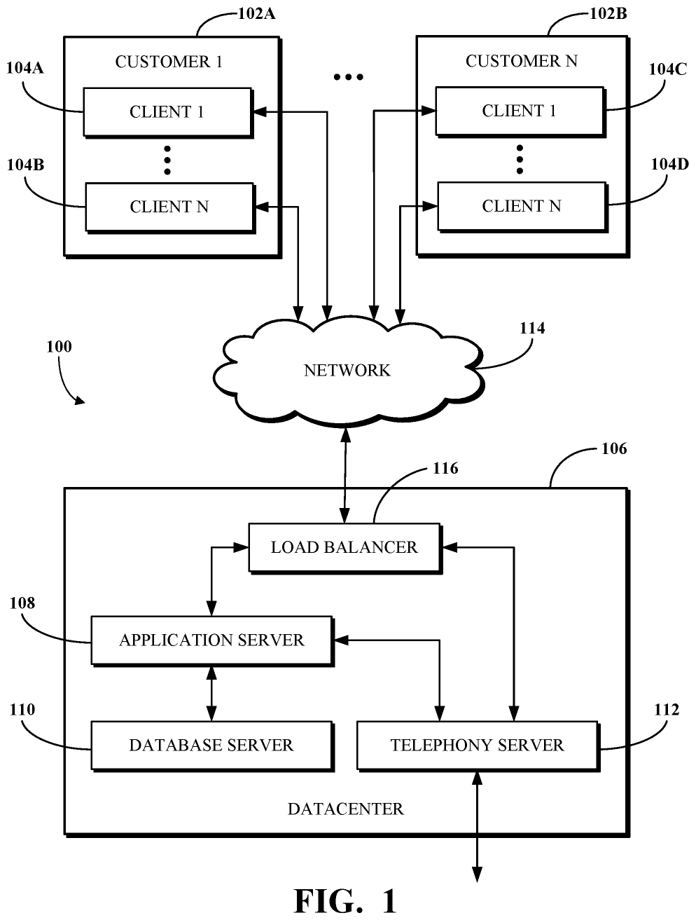

To describe some implementations in greater detail, reference is first made to examples of hardware and software structures used to implement a system for virtual background image generation during video conferences. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client. In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

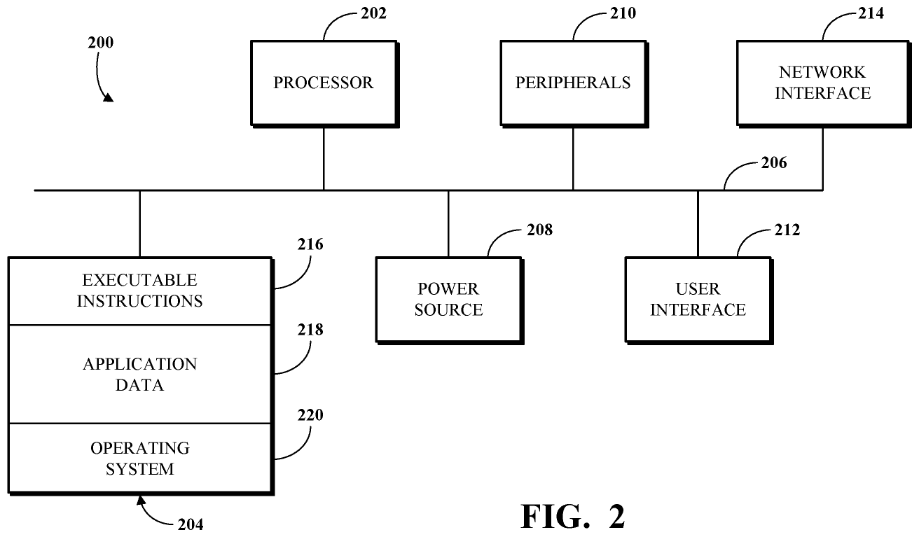

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

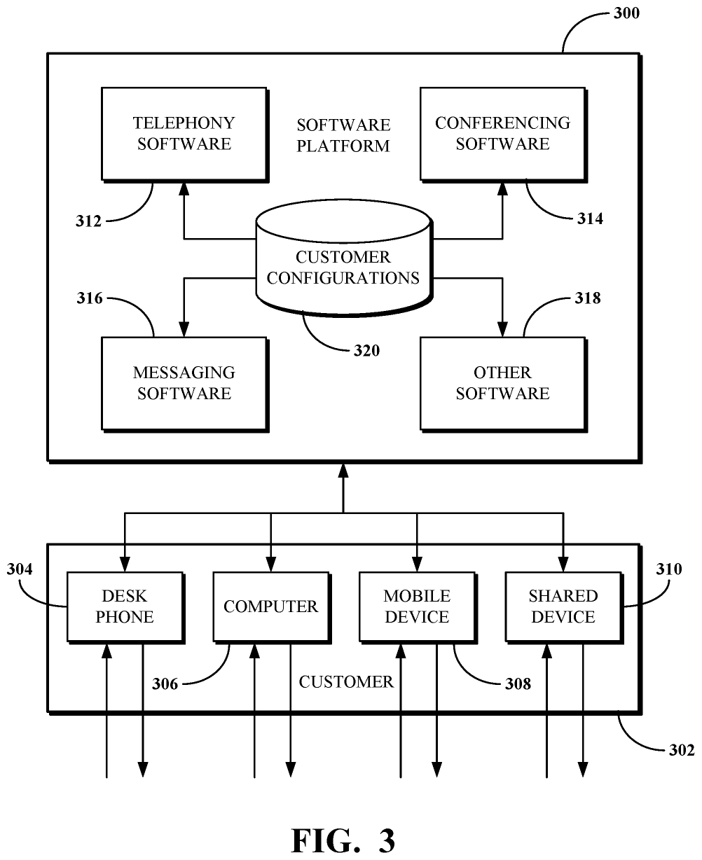

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include generative artificial intelligence software for generating virtual background images during video conferences. In some cases, the conferencing software 314 may include the other software 318. The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

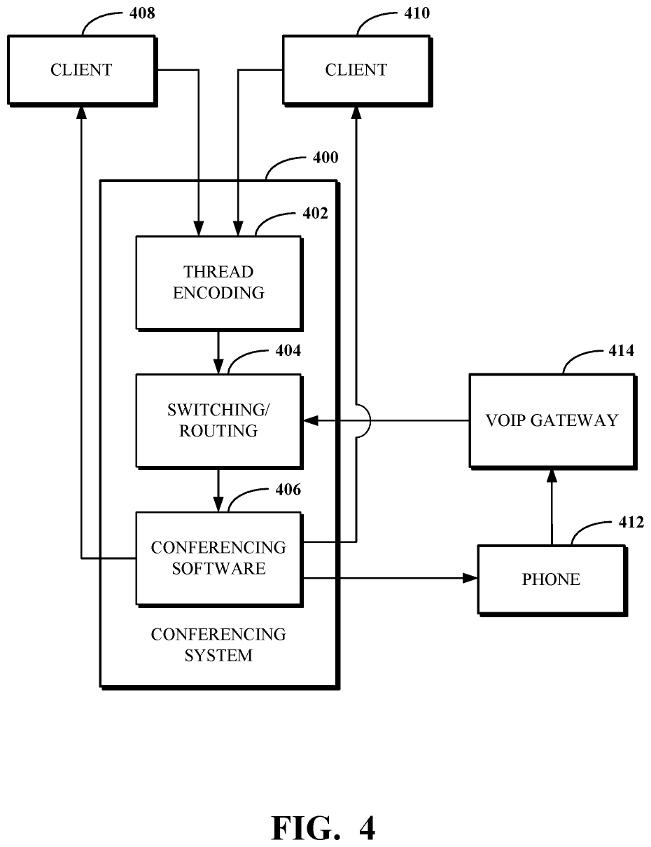

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

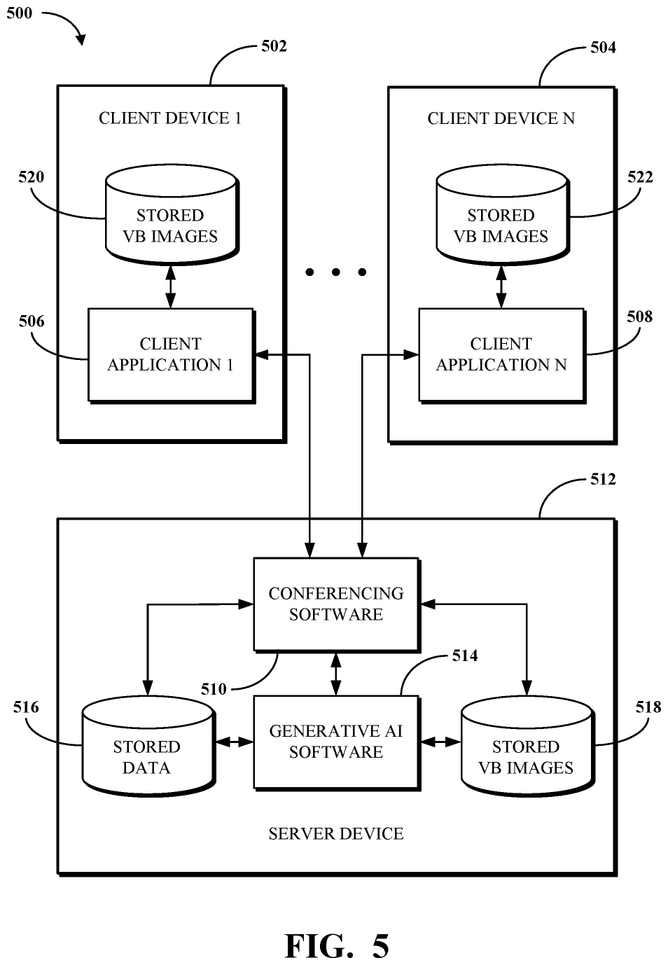

FIG. 5 is a block diagram of an example of a conferencing system 500 that generates virtual background images for use with participant video streams during video conferences. For example, the conferencing system 500 may be the conferencing system 400 shown in FIG. 4. The conferencing system 500 facilitates video conferences between participants using client devices 1 502 through N 504, which may, for example, each be one of the clients 408 or 410 shown in FIG. 4, and in which Nis an integer greater than one.

Each of the client devices 1 502 through N 504 runs a respective client application 1 506 through N 508, in which Nis an integer greater than one and generally corresponds to the value of N used with the client devices 1 502 through N 504. The client applications 1 506 through N 508 may, for example, be separate installations, instances, versions, or other runtime executions of client-side software used to connect to conferencing software 510 at a server device 512. The conferencing software 510 may, for example, be the conferencing software 314 shown in FIG. 3. The server device 512 may, for example, be the application server 108 shown in FIG. 1. For example, the server device 512 may be a server owned and/or operated by or on behalf of a software platform, such as the software platform 300 shown in FIG. 3.

The client devices 1 502 through N 504 may be located in a same physical space (e.g., a conference room), different physical spaces within a same geographic area (e.g., separate offices at an office premises), or in different geographic areas (e.g., separate locations, regardless of distance). The client devices 1 502 through N 504 connect to the server device 512 over a network, which may, for example, be the network 114 shown in FIG. 1.

Each of the client devices 1 502 through N 504, via their respective client applications 1 506 through N 508, may transmit a video stream to the conferencing software 510 for processing and ultimate rendering within video conference GUIs at each of the client devices 1 502 through N 504. In particular, the conferencing software 510 processes the video streams received from the client devices 1 502 through N 504 and transmits processed video stream data back to those devices to cause those devices to render the processed video stream data within a GUI of the conferencing software 510 output for display at some or all of the client devices 1 502 through N 504. For example, the GUI may include multiple user interface tiles each displaying a rendered video showing one or more of the conference participants.

Each of the client applications 1 506 through N 508 may be configured to apply, modify, or otherwise use a virtual background image in connection with the video streams transmitted thereby to the conferencing software 510. That is, each of the client applications 1 506 through N 508 enables a user of the respective client device 1 502 through N 504, who is a participant of the video conference implemented using the conferencing software 510, to use a virtual background image to replace an actual background initially depicted within images of a video stream captured by a camera of that client device. A virtual background image may be applied, modified, or otherwise used before the video conference begins (e.g., while a participant thereof is in a virtual waiting room of the video conference) or at one or more times during the video conference.

To use a virtual background image to replace an actual background within images of a video stream, a client application performs a segmentation process to effectively clip out, from the images of the video stream, a portion of the images depicting the conference participant using the respective client device and to combine that clipped out portion with the virtual background image to produce composite images depicting both the conference participant and the contents of the virtual background image. To combine the clipped out portion with the virtual background image contents, the clipped out portion is treated as a foreground that remains layered on top of the virtual background image such that contents of the virtual background image which are behind the foreground may not be perceptible. For example, an artificial neural network (ANN) that is trained to extract human body features from imagery, for example, via object recognition, may be used to identify the foreground. The ANN may be trained using images of humans, with the part of the image that includes a human labeled (e.g., by a human user). The ANN may include a layer or a sub-network that detects edges and is trained to detect edges based on labeled edges within imagery that includes humans and/or thing that are different from humans. The foreground is then overlaid over the virtual background image, causing a portion of the virtual background image that is behind the foreground to become obscured. The client application then transmits the composite images as the video stream for the conference participant to the conferencing software 510. A virtual background may be applied for use with a video conference before a conference participant joins the video conference. Alternatively, a virtual background may be applied during the video conference.

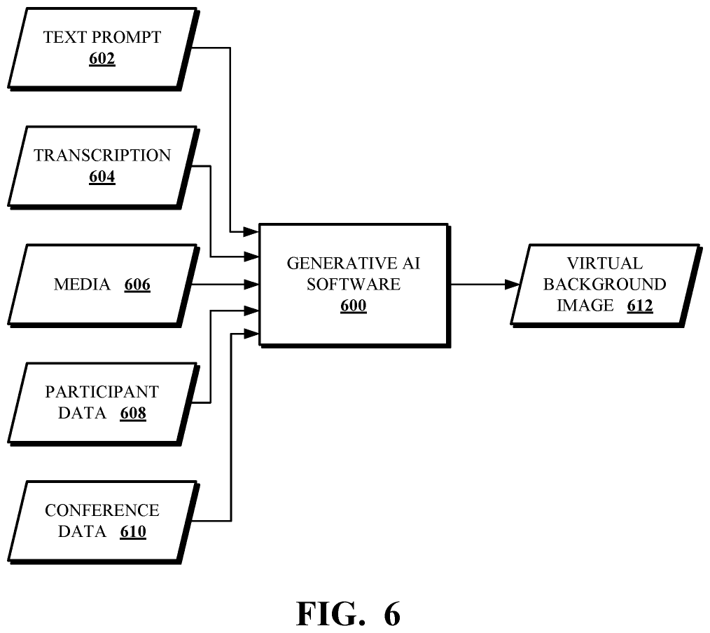

The conferencing system 500 is configured to generate (i.e., create, as new images or update, from previous versions of images) virtual background images for use with video streams of the client devices 1 502 through N 504 using generative artificial intelligence software 514. The generative artificial intelligence software 514 may, as described above, be, include, or otherwise use one or more trained models including one or more of LLM, GPT, NLP, GAN, VAE, ARM, or like technology to process input to generate, as output, a virtual background image. The input may be associated with one or more participants of the video conference (i.e., as users of the client devices 1 502 through N 504), the video conference itself, media shared to the video conference, conversations occurring during the video conference, or the like, or a combination thereof. In some cases, at least some such input may be obtained from stored data 516, representing a data store including information associated with the video conference, one or more participants thereof, and/or the like. The input may be obtained directly from a participant (e.g., transmitted or otherwise obtained from their client device) and/or without manual user intervention. Implementations and examples of input and output of the generative artificial intelligence software 514 are shown and described with respect to FIG. 6.

The generative artificial intelligence software 514 obtains the input from the conferencing software 510, whether as directly provided by a conference participant or obtained without manual user intervention. For example, text input presented by a participant using a client device may be obtained within a GUI of the conferencing software 510 at the client device and accordingly transmitted from the client application running at that client device to the conferencing software 510. The conferencing software 510 may accordingly pass the text input to the generative artificial intelligence software 514 to cause the generative artificial intelligence software 514 to use the text input to generate a virtual background image. In another example, input obtained or otherwise derived from a transcription of a video conference facilitated using the conferencing software 510 (e.g., a real-time transcription generated during the video conference using automated speech recognition (ASR) or like functionality of or otherwise accessible to the conferencing software 510) may be automatically passed from the conferencing software 510 to the generative artificial intelligence software 514 to cause the generative artificial intelligence software 514 to use the transcription input to generate a virtual background image. Other examples are possible.

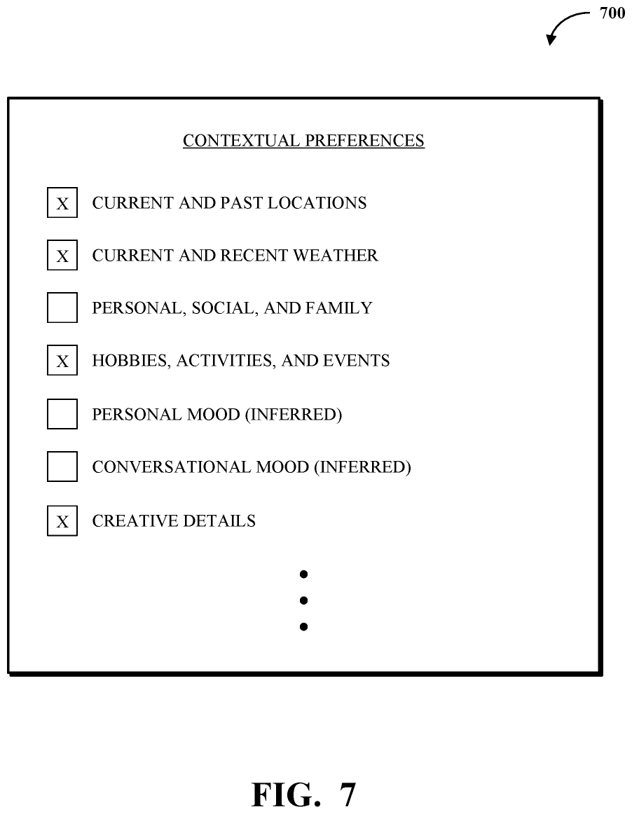

The generative artificial intelligence software 514 generates the virtual background image based on the input by encoding the input using a transformer encoder process that identifies the key concepts of the input and decoding the encoded input using a transformer decoder process that refines the encoded input into an image representation. For example, the virtual background image generation may be performed using a transformer artificial neural network (TANN) or a series of multiple TANNs. Generating the virtual background image can include generating a new image based on the input or updating an existing image based on the input. For example, a new image may be generated to replace a current background within a participant video stream. In another example, an existing image may be updated to include visual elements determined based on the input to cause those visual elements to be included within a participant video stream. Implementations and examples of generating a virtual background image are shown and described with respect to FIG. 7.

The generative artificial intelligence software 514 outputs the virtual background image generated thereby to the conferencing software 510 to cause the conferencing software 510 to output the virtual background image to one or more of the client devices 1 502 through N 504. For example, where the input used to generate the virtual background image was obtained from a certain client device, the virtual background image may be transmitted specifically (e.g., exclusively) to that client device (e.g., in response to the input). In another example, where the input used to generate the virtual background image was obtained from a certain client device but with instructions to assert the virtual background image against some or all of the client devices 1 502 through N 504, the virtual background image may be transmitted to those some or all of the client devices 1 502 through N 504. In yet another example, where the input used to generate the virtual background image was obtained by the conferencing software 510 without manual user intervention, the virtual background image may be transmitted to one or more client devices which are identified as corresponding to the input.

The generative artificial intelligence software 514 may utilize one or more machine learning models to generate a virtual background image. The one or more machine learning models may be trained using contents derived from any of a variety of sources. For example, the one or more machine learning models may be trained in a multi-phase training process. The image generation engine 512 may be trained in a multi-phase training process. In a first phase of the training, such a machine learning model is trained to generate an image from an input, which may, in some cases, be unrelated to video conferencing. In a second phase of the training, the machine learning model is finetuned to generate virtual background images for video conferencing. During the finetuning phase, the machine learning model is finetuned on specific tasks (e.g., generating an image generation prompt based on a natural language input associated with a video conference) using labeled examples. The labeled examples may be publicly available recordings of video conferences, and manually (e.g., by a human user) generated prompts for relevant virtual backgrounds. The labeled examples may include labels of desired outputs that the machine learning model is to generate based on the inputs. In some cases, the finetuning can include training the machine learning model using input from a human reviewer.

Regardless of the manner by which the virtual background image is output, a client application receiving the virtual background image may, upon receipt of the virtual background image, begin to produce composite images as described above so as to cause further images within the video stream from that client application to include the virtual background image. In some cases, the client application may automatically apply (e.g., assert) the virtual background image to produce composite images (i.e., without manual user approval). In some cases, the client application may output a prompt requesting that the participant using the respective client device approve the use of the virtual background image within their video stream prior to such use.

In some cases, the generative artificial intelligence software 514 may generate multiple candidate virtual background images based on the input obtained thereby. In such a case, one of those multiple candidate virtual background images is selected as the virtual background image, whether by a participant using a respective client device or by a software aspect (e.g., a client application or the generative artificial intelligence software 514). For example, multiple candidate virtual background images may be output for selection within a prompt by at a client device (i.e., via a respective client application running thereat). The participant using that client device may manually select one of the multiple candidate virtual background images to use as their virtual background image, at which point the selected virtual background image may be used by the client application within a video stream. In another example, the generative artificial intelligence software may perform a scoring evaluation process against the multiple candidate virtual background images to measure a quality of each of one or more criterion, such as depiction of objects described in the input, comparisons between those depictions and expected representations of similar objects, color variance within the image, or the like. The candidate virtual background image with a highest one of the scores may thus be selected as the virtual background image and output for use within a participant video stream.

One or both of the conferencing software 510 or the generative artificial intelligence software 514 may include a software agent (e.g., as an artificial intelligence companion) configured to identify input for the generative artificial intelligence software 514 to use to generate a virtual background image. For example, input obtained based on manual user intervention (e.g., via a text input entered by a participant within a GUI output at a client application) may be received by a software agent at a client application into which the input is typed. In another example, where the input is obtained other than by manual user intervention (e.g., based on a conversational context of the video conference captured within a real-time transcription), a software agent can listen for certain content that may reasonably trigger a virtual background image generation process. That is, a conversational context representing semantic and syntactic information relevant to a portion of the video conference can be determined as input for the generative artificial intelligence software 514 using a real-time transcription of the video conference. For example, dialog between participants about what a certain landmark within a certain city looks like may be inferred by the software agent as a request for a virtual background image and accordingly provided as input therefor. In some cases, where a virtual background image is generated by an automated process (e.g., initiated via a software agent), user approval will be required to assert the virtual background image against one or more participant video streams.

The virtual background image generation process performed using the generative artificial intelligence software 514 may be performed one or more times during a video conference. For example, a participant using a client device may transmit multiple requests as text input for different types of virtual background images and/or different iterations of a same virtual background image. In another example, the generative artificial intelligence software 514 may generate multiple virtual background images at each of various times throughout a video conference based on the conversational context of the video context. Other examples are possible. In some cases, a policy may be asserted to limit the number of times that virtual background images may be generated or asserted on a video conference or participant basis, such as to minimize disruption to the conference experience that may otherwise result from participant attention being focused on the changing images.

Virtual background images generated using the generative artificial intelligence software 514 may be stored in one or more locations for future use. For example, the server device 512 may include stored virtual background images 518 within a data store accessible by one or more participants, one or more customer accounts, or the like. In one non-limiting example, the stored virtual background images 518 may be stored for use with future occurrences of a recurring conference series (e.g., a weekly team meeting). In some cases, the virtual background images generated for or on behalf of a given participant may be stored locally at a client device of that given participant. For example, the client devices 1 502 through N 504 may include stored virtual background images 520 through 522 within local data stores. During a future video conference, the client applications 1 506 through N 508 may access those local data stores to make the stored virtual background images 520 through 522 available for selection and use at those client devices 1 502 through N 504. In some cases, one or more of the stored virtual background images 518, the stored virtual background images 520, or the stored virtual background images 522 may be omitted.

Implementations of the conferencing system 500 may differ from what is shown and described. In some implementations, the conferencing software 510 may include the generative artificial intelligence software 514. In such a case, input obtained at the conferencing software 510 (e.g., originating at a client device or at the conferencing software 510) may be processed by the generative artificial intelligence software 514 without such input being transmitted between separate software aspects.

In some implementations, the generative artificial intelligence software 514 may be located and thus accessed at a server other than the server device 512. For example, the other server may be operated by or on behalf of the same entity for which the server 512 and thus may be under the control of the same entity or a different entity. In some implementations, the generative artificial intelligence software 514 may be located locally at each of one or more of the client devices 1 502 through N 504. For example, some or all of the client devices 1 502 through N 504 may each operate (e.g., within or otherwise in connection with the respective client application running thereat) a local instance, installation, or other runtime execution of the generative artificial intelligence software 514. In at least some such cases, the input used by the generative artificial intelligence software 514 to generate a virtual background image may be obtained and processed locally at a respective client device. In at least some cases where the generative artificial intelligence software 514 is located locally at the one or more of the client devices 1 502 through N 504, the generative artificial intelligence software 514 may accordingly be omitted from the server device 512.

In some implementations, the generative artificial intelligence software 514 may interface directly with some or all of the client applications 1 506 through N 508. In at least some such cases, the conferencing software 510 may not operate as an intermediary between the subject client application and the generative artificial intelligence software 514, such that input may instead be obtained by the generative artificial intelligence software 514 directly from the client application and the resulting virtual background image may be obtained by the client application directly from the generative artificial intelligence software 514.

FIG. 6 is a block diagram of examples of inputs and output of generative artificial intelligence software 600 used for video conferences. For example, the generative artificial intelligence software 600 may be the generative artificial intelligence software 514 shown in FIG. 5. The examples of inputs which may be obtained and used by the generative artificial intelligence software 600 include a text prompt 602, a transcription 604, media 606, participant data 608, and conference data 610. The generative artificial intelligence software 600 uses ones or combinations of ones of those inputs 602 through 610 to generate, as output, a virtual background image 612 for use within a participant video stream during a video conference.

The text prompt 602 is or includes text input (i.e., including a combination of letters, numbers, punctuation, and/or other characters in one or more spoken languages) obtained from a client application of a participant. The text prompt 602 may be typed by a participant within a text input box presented in a GUI of a video conference, as rendered by the client application. For example, the text input box may be a user interface input element configured for single-purpose use (e.g., as a dedicated text input box for receiving the text prompt 602) or for multiple-purpose use (e.g., as a text input box usable to provide text input for generative artificial intelligence processing, for sending and/or receiving messages between video conference participants, and/or to interact with an artificial intelligence companion software agent of the video conference for one or more reasons). Text prompts 602 may be obtained from a client application for use with the participant using that specific client application (e.g., a host or general participant) and device or for use with multiple participants (e.g., some or all participants of the video conference or within one or more breakout rooms of the video conference). One illustrative and non-limiting example of the text prompt 602 may be “make an image of Carlsberg in Denmark in the evening with lousy weather and a spooky mood”).

The transcription 604 is or includes some or all of a transcription of a video conference. For example, the transcription 604 may be a real-time transcription produced on-the-fly throughout the video conference. The transcription 604 may include speech content spoken by participants as well as metadata or other information usable to identify speakers. The transcription 604 may be generated using an ASR tool of the conferencing software that uses the generative artificial intelligence software 600 (e.g., the conferencing software 510 shown in FIG. 5). For example, the conferencing software can include the ASR tool or the ASR tool may be external to the conferencing software (e.g., running at a same or different server). In either case, a software agent operating in connection with the conferencing software or the generative artificial intelligence software 600 is exposed to the transcription 604 throughout the video conference and thus can access and use the transcription 604 as it is produced. The transcription 604 may or may not be exposed to individual client applications connected to the video conference. For example, a host may have access to the transcription 604 throughout the video conference, but a non-host participant may only be able to access the transcription 604 after the video conference has concluded. One illustrative and non-limiting example of the transcription 604 may include speech content representing a conversation between video conference participants about an upcoming trip to Hawaii.

The media 606 is or includes one or more image, video, and/or audio media items. The media 606 may be derived from the video conference or the conferencing software used to facilitate the video conference. For example, the media 606 may represent one or more previously generated virtual background images (e.g., stored within a virtual background image library) for one or more past video conferences, media shared to the video conference (e.g., via a screen share presentation by one or more participants thereof), or media identified for use with the video conference (e.g., music, as an audio file, intended for output in between sessions of a video conference webinar). Alternatively, the media 606 may be derived from a source external to the video conference and such conferencing software. For example, the media 606 may be or include one or more images, video, and/or audio media items obtained from a royalty-free online media distribution platform or from a commercial partner entity under license rights. In some cases, as alluded to above, the media 606 may include one or more media items generated using the generative artificial intelligence software 600 (e.g., for a same or a different video conference) or using other generative artificial intelligence software. One illustrative and non-limiting example of the media 606 may include an image file depicting a company logo of a customer of a UCaaS platform that provides conferencing software.

The participant data 608 is or includes data associated with one or more participants of a video conference. For example, the participant data 608 for a given conference participant may, subject to consent being given (e.g., via an opt-in mechanism), include one or more of the name of or other user identifier associated with the conference participant, a location of the conference participant, a device type used by the conference participant (e.g., as their client device), an operating system type used by the device of the conference participant, conference attendance or related history information for the conference participant, or the like. The participant data 608 for a given conference participant may be derived from the client device of the conference participant (e.g., via the client application running thereat) and/or a server device used for the conferencing system that facilitates the video conference. In some cases, the participant data 608 may include contextual preferences defined for or otherwise on behalf of one or more participants of a video conference. Implementations and examples of such contextual preferences are described below with respect to FIG. 7. One illustrative and non-limiting example of the participant data 608 can include a current location of a client device used by a participant to connect to a video conference, which may, for example, be obtained based on an IP address of that client device.

The conference data 610 is or includes data associated with the video conference for which the generative artificial intelligence software 600 is in use. For example, the conference data 610 may include one or more of a title of the video conference, a start and/or end time of the video conference, a host name of the video conference, an agenda of the video conference, an indication of whether the video conference is a single occurrence or part of a recurring series, a customer associated with a user account used to schedule the video conference, a current mood of the video conference (e.g., inferred based on participant speech and/or body language) or the like. The conference data 610 may be derived from a client device of a conference participant (e.g., a host thereof, via the client application running at their client device) and/or a server device used for the conferencing system that facilitates the video conference. In some cases, the conference data 610 may include contextual preferences defined for or otherwise on behalf of a video conference. Implementations and examples of such contextual preferences are described below with respect to FIG. 7. One illustrative and non-limiting example of the conference data 610 can include an agenda of a video conference indicating the key topics under discussion during the conference.

FIG. 7 is an illustration of examples of contextual preferences usable for generating a virtual background image for one or more participants of a video conference. The contextual preferences include one or more items which may be selected by or otherwise on behalf of each of one or more conference participants, either prior to or during a subject video conference. The contextual preferences thus operate as definitions of types of information which may be evaluated and used by generative artificial intelligence software (e.g., the generative artificial intelligence software 600 shown in FIG. 6 and/or the generative artificial intelligence software 514 shown in FIG. 5) to generate a virtual background image.

The contextual preferences may be defined at the individual conference participant level (i.e., by or on behalf of a single conference participant), at the group conference participant level (i.e., by or on behalf of multiple (e.g., some or all) conference participants, for example, all presenting participants or all non-presenting participants), or at the video conference level (i.e., independent of the participants thereof). In the examples shown, the contextual preferences are presented within a GUI of a client application (i.e., of a host or non-host participant of a video conference to occur in the future or actively occurring in the present). The GUI includes a list of elements next to respective ones of the contextual preference items. The elements are interactive and thus may be manually and selectively enabled or disabled, as desired.

The illustrative and non-limiting examples of contextual preferences shown include: current and past locations; current and recent weather; personal, social, and family; hobbies, activities, and events; personal mood (inferred), conversational mood (inferred), and creative details. The illustrative and non-limiting examples of definitions of each of these will now be described. Current and past locations can be, include, or otherwise refer to a current or past location of a conference participant, a group of conference participants (e.g., attending a video conference together using a single client device), or of the video conference itself (e.g., expressed as the location of the client device of the host of the video conference unless separately defined). Current and recent weather can be, include, or otherwise refer to one or more weather events, trends, forecasts, or the like at a location of the current and past locations. Personal, social, and family can be, include, or otherwise refer to information deemed to be personal to a conference participant or group thereof, information that is personal (e.g., private) to a customer associated with a user account used to schedule a video conference, social information or activities related to one or more conference participants, and family information or activities related to one or more conference participants. Hobbies, activities, and events can be, include, or otherwise refer to information that corresponds to activities and events other than those which may be covered by the personal, social, and family elements. Personal mood (inferred) can be, include, or otherwise refer to information about the mood of one or more participants, which may be inferred, for example, by inputs such as the text prompt 602, the transcription 604 shown in FIG. 6, and/or other speech and/or body language aspects of the participant or participants. Conversational mood can be, include, or otherwise refer to information about the mood of the video conference according to current and/or past conversation(s) during the video conference, which may be inferred, for example, by inputs such as the text prompt 602, the transcription 604 shown in FIG. 6, and/or other speech and/or body language aspects of the participant or participants. Creative details can be, include, or otherwise refer to information that can be deemed to address, modify, or relate to one or more inputs usable to generate a virtual background image.

In the examples shown, the contextual preferences may be of a single conference participant who is selectively enabling and disabling ones of the contextual preferences to define their use for an upcoming or in-progress video conference. The conference participant accesses the contextual preferences within a GUI of the client application running at their client device. The conference participant has enabled use of: current and past locations; current and recent weather; hobbies, activities, and events; and creative details. As such, the other contextual preferences are deemed disabled and thus not used for generating virtual background images.

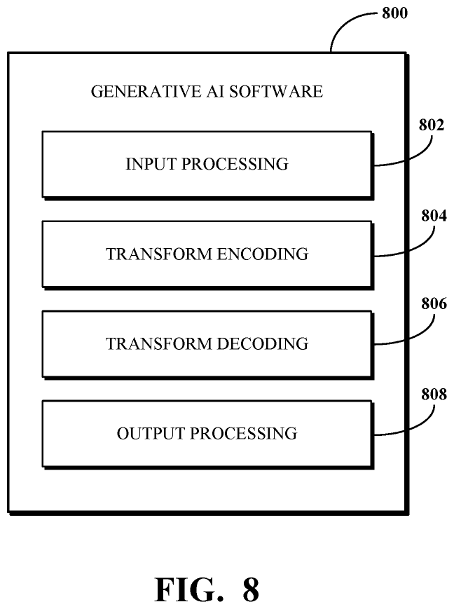

FIG. 8 is a block diagram of example functionality of generative artificial intelligence software 800 used for video conferences. For example, the generative artificial intelligence software 800 may be the generative artificial intelligence software 600 shown in FIG. 6 and/or the generative artificial intelligence software 514 shown in FIG. 5. The generative artificial intelligence software 800 includes tools, such as programs, subprograms, functions, routines, subroutines, operations, and/or the like, for generating virtual background images during video conferences. As shown, the generative artificial intelligence software 800 includes an input processing tool 802, a transform encoding tool 804, a transform decoding tool 806, and an output processing tool 808.

The input processing tool 802 obtains input upon which the generation of a virtual background image will be based. The input may, for example, be or include one or more of the inputs 602 through 610 shown in FIG. 6. The input processing tool 802 processes the input to prepare it for use with virtual background image generation. For example, the input processing tool 802 may generate an image generation prompt including one or more of geographic locations, nouns, or noun-phrases that are associated with imagery. Examples of such key words include “Key West,” “Aspen,” “camels in desert on sunny day,” “monsoon,” “jungle thunderstorm,” or “coffee shop.” The input processing tool 802 can use predictive analysis to predict one or more additional words to use for the virtual background image generation based on a training of the machine learning model(s) used for such generation. For example, a transformer architecture (e.g., of a GPT or LLM) may capture dependencies between words and create a representation of the input.

The transform encoding tool 804 generates an encoded representation of the input as processed by the input processing tool 802. For example, the transform encoding tool 804 may use a TANN or other architecture to analyze semantic and syntactic relationships within the input as processed by the input processing tool 802. The transform encoding tool 804 determines, by analyzing the semantic and syntactic relationships, key concepts of the input as processed by the input processing tool 802 and translates (e.g., encodes) those key concepts into a latent representation suitable for image generation. The transform decoding tool 806 processes the encoded representation of the input, as determined using the transform encoding tool 804, and uses another TANN to gradually refine the latent information thereof into an image representation. For example, the transform decoding tool 806 may iteratively predict pixel values and their relationships, guided by the encoded representation of the input and internal knowledge according to a training of the TANN. In some implementations, a refinement phase is performed to refine (i.e., increase) a quality of the image generated based on the input. For example, the refinement phase may include using progressive up-sampling to progressively refine details and textures of the generated image, using style-transfer to incorporate particular style elements within the generated image, or the like.

The output processing tool 808 outputs the generated virtual background image for use within one or more participant video streams during a video conference. For example, the output processing tool 808 can cause the generative artificial intelligence software 800 or other software intermediate to the generative artificial intelligence software 800 and a client device of a video conference participant to transmit the virtual background image to that client device so that a client application running thereat can begin producing composite images using the virtual background image. In some cases, the output processing tool 808 may also cause the generated virtual background image to be stored within a datastore.

Although the tools 802 through 808 are shown as separate tools, in some implementations, two or more of the tools 802 through 808 may be combined into a single tool. Although the tools 802 through 808 are shown as functionality of the generative artificial intelligence software 800 as a single piece of software, in some implementations, some or all of the tools 802 through 808 may exist outside of the generative artificial intelligence software 800, or the generative artificial intelligence software 800 may be implemented as multiple software aspects running at the same or different computing devices.

In some implementations, the generative artificial intelligence software 800 may use a decoder-only transformer that autoregressively generates the virtual background image. During autoregressive generation, the decoder-only transformer tokenizes the input processed by the image processing tool 802 into smaller units (words, sub-words, or characters) and then transforms those smaller units into fixed-dimensional embeddings. These embeddings represent the semantic meaning of the input tokens and serve as the initial input to the decoder-only transformer. Positional encoding is added to the input embeddings to provide information about the order or position of tokens in the input sequence. This enables the decoder-only transformer to consider the sequential structure of the natural language input. Such a decoder-only transformer may comprise multiple layers, each containing self-attention mechanisms. These mechanisms allow the decoder-only transformer to weigh the importance of different parts of the input text while generating the corresponding visual features. Self-attention enables the model to capture dependencies and relationships between different words or tokens in the natural language input. Within each decoder layer, the multi-head attention mechanism allows the decoder-only transformer to attend to different parts of the input text simultaneously. Additionally, feedforward neural networks within each layer further process the information and refine the generated image features. The final layer of the decoder-only transformer processes the generated visual features to reconstruct or generate the output image. This layer might employ additional artificial neural network components or transformations to convert the visual features into a coherent and accurate representation of the image corresponding to the natural language input.

In some implementations, the generative artificial intelligence software 800 may include one or more other tools in addition to the tools 802 through 808. For example, the generative artificial intelligence software 800 may include a text analysis tool for identifying key points within one or more conversations occurring during a video conference, noting that such a conversation may include one or more speakers and thus that even a single speaker conversation (e.g., an uninterrupted presentation or lecture) is considered a conversation. The text analysis tool may use a machine learning model that is the same as or different from the machine learning model used by the tools 804 and 806 for image generation. For example, the text analysis tool may use text-based machine learning model (e.g., a GPT or LLM) to evaluate text-based input such as a transcription of the video conference, participant input obtained directly from a client application, or the like or a combination thereof to identify, as a key point, a topic that important to some or all of the one or more conversations. The topic may be represented as a short phrase, such as a title, or as a more expansive expression, such as a summary. The text analysis tool may perform this text analysis process against subject input at one or more times during a video conference, for example, according to triggering events detected or received by a software agent.

In some implementations, the generative artificial intelligence software 800 may generate a virtual background image by selecting the virtual background image from a datastore. For example, one or more virtual background images generated before a subject video conference may be maintained within a virtual background image library (e.g., as the stored virtual background images 518 shown in FIG. 5.). The output of the tool 802 or the tool 804, indicating a parsing of the input to use to generate a virtual background image, may be processed to determine classification or other identifying information associated with that input (e.g., the input “make a background that shows the Eiffel Tower in Paris, France” can be parsed to determine that the input corresponds to the Eiffel Tower). The virtual background image library, or data or metadata thereof, can then be searched according to that determined classification or other identifying information to determine whether a virtual background image corresponding thereto is already present within the virtual background image library.

In the event such a virtual background image is present within the virtual background image library, the virtual background image may be presented for participant selection or automatically output for participant video stream use, as the case may be. In the event such a virtual background image is not present within the virtual background image library, the software 800 may advance to the tool 806 to cause a new virtual background image to be generated based on the input. In the event that a virtual background image present within the virtual background image library is presented for participant selection, as described above, and the participant indicates to not use the virtual background image (e.g., because the virtual background image does not accurately depict or otherwise represent desired content for a participant virtual background, whether or not the image selected from the library is appropriate to the input), a different virtual background image relevant to the input may be identified and presented for participant selection, if available, or the software 800 may advance to the tool 806 to generate a new virtual background image based on the image.

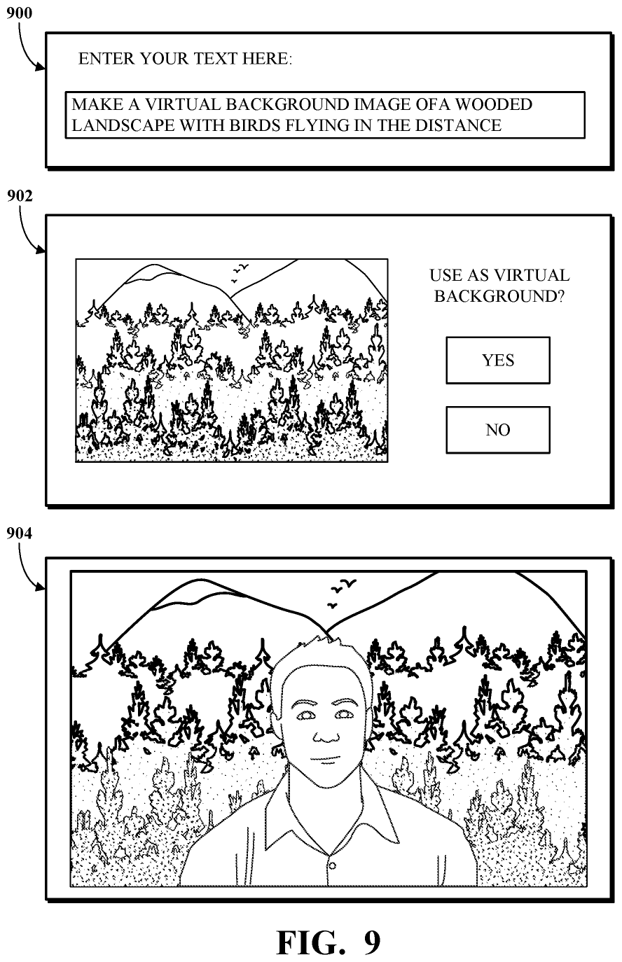

To further describe some implementations in greater detail, reference is next made to example illustrations representing use cases for a system for virtual background image generation during video conferences. FIG. 9 is an illustration of examples of GUIs 900 through 904 associated with generating a virtual background image for a participant of a video conference. The GUI 900 depicts a text input box which may be rendered for display within a client application running at a client device. For example, the text input box may correspond to a software agent (e.g., an artificial intelligence companion) usable with a video conference. A conference participant may use the text input box to input (e.g., type) a text prompt that will be used as the input to generate a virtual background image. Here, the text prompt recites “Make a virtual background image of a wooded landscape with birds flying in the distance.” The GUI 902 depicts a selection option presented at the client application at which the GUI 900 was rendered for display. In particular, the GUI 902 presents the virtual background image generated based on the input shown in the GUI 900 along with two interactive elements allowing the user of the client application to approve or reject use of the generated virtual background image. The GUI 904 depicts a user interface tile output for rendering within a GUI of a video conference in which a video stream of the conference participant who used the GUIs 900 and 902 is shown with the participant in a foreground thereof and the virtual background image as the background thereof.

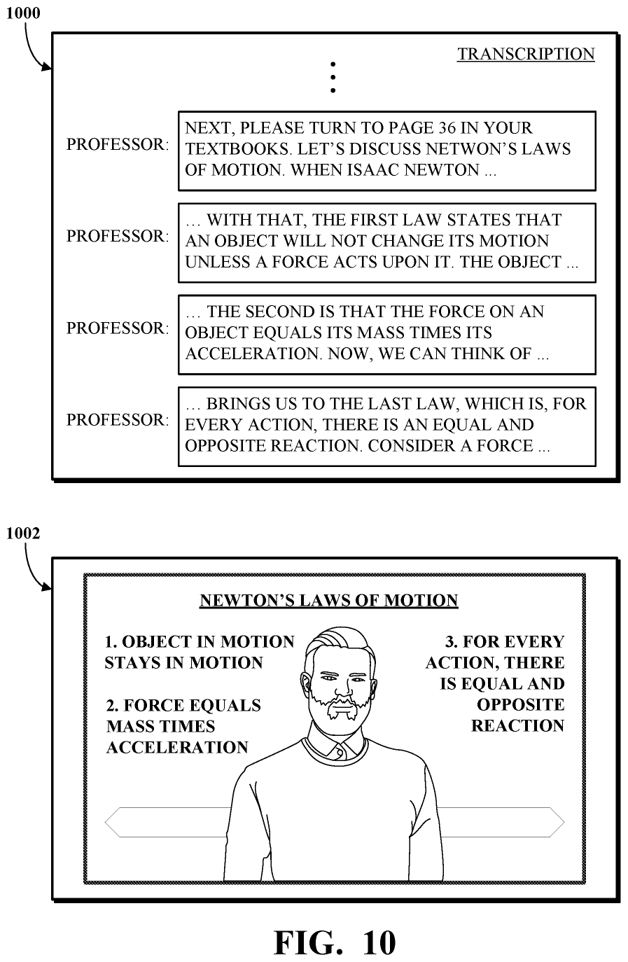

FIG. 10 is an illustration of examples of GUIs 1000 through 1002 associated with outputting video conference key points within a virtual background image for a participant of a video conference. The GUI 1000 depicts portions of a transcription of a video conference during which a professor is lecturing to a physics class about Newton's laws of motion. The transcription includes different contents addressing different portions of the professor's lecture, which, in relevant part, address Isaac Newton's three laws of motion at length. An initial virtual background image of the professor includes a polygon behind him simulating a game show visual. However, in the GUI 1002, the initial virtual background image is updated into an updated virtual background image, and is shown as part of a participant video stream output for rendering within a user interface tile of a GUI of the video conference. In particular, the updated virtual background image shown in the GUI 1002 includes visual elements each representing a different one of the laws of motion, which are determined as key points of the video conference, along with a summary visual element at a top portion thereof.

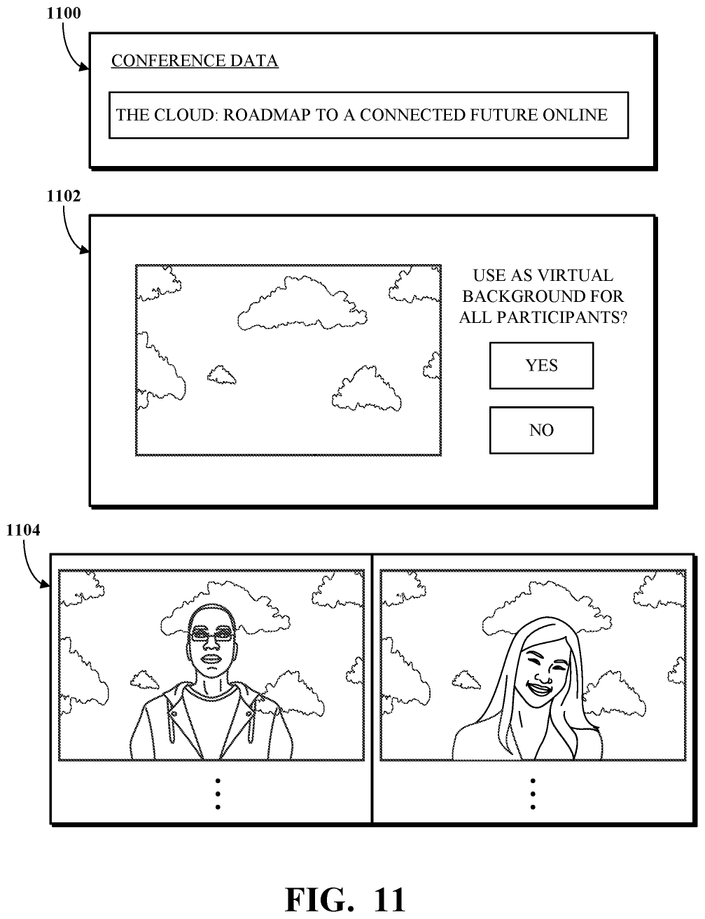

FIG. 11 is an illustration of examples of GUIs 1100 through 1104 associated with generating a unified virtual background image for multiple participants of a video conference. The GUI 1100 depicts conference data including a title of a video conference, which is a webinar to be attended by multiple participants, including presenting participants and non-presenting participants. The title of the webinar is “The Cloud: Roadmap to a Connected Future Online.” Based on the conference data (i.e., the title) as input, a virtual background image depicting clouds in a sky is generated and shown in the GUI 1102 as being available for selection or rejection by a conference participant (e.g., a host of the webinar). The GUI 1104 shows user interface tiles within which different participant video streams are rendered for display during the webinar, in which each of the multiple participant video streams uses the unified virtual background to create an immersive video conference experience.

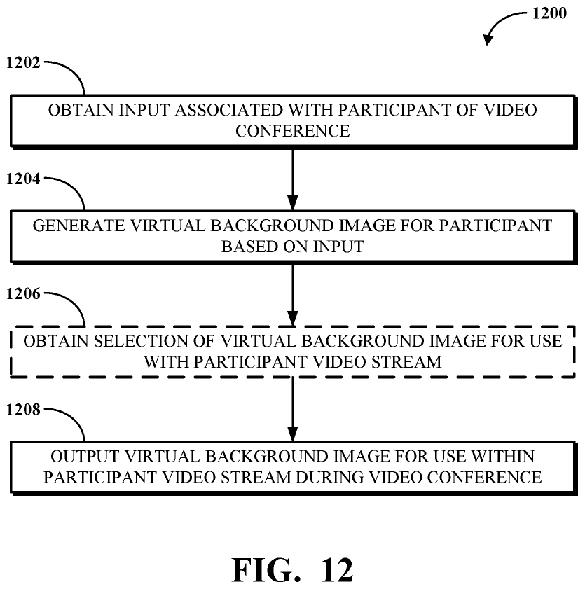

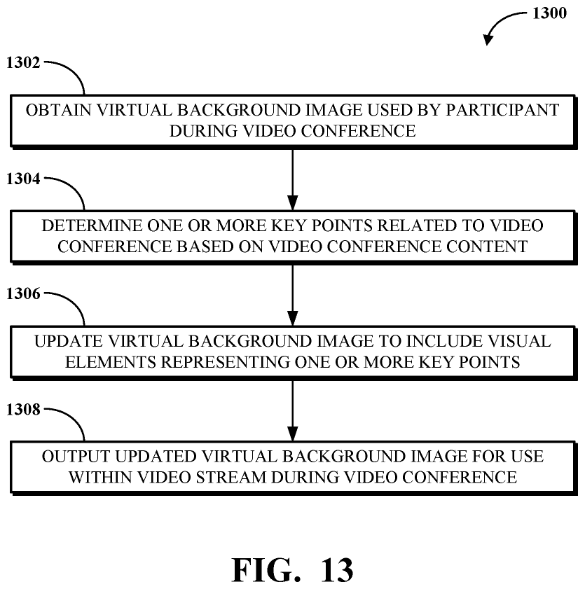

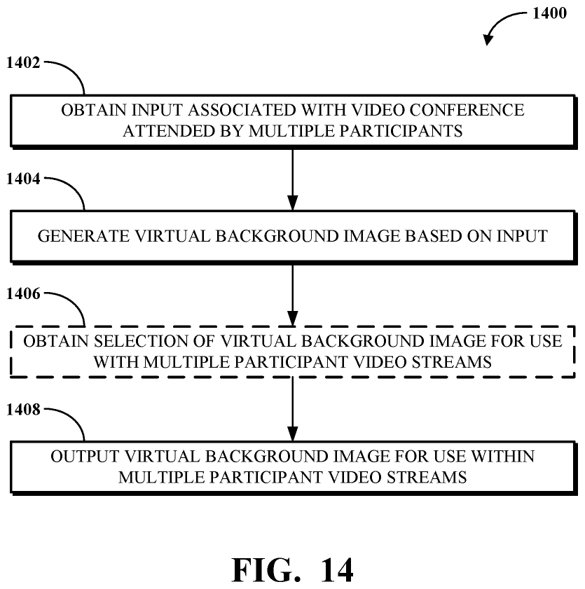

To further describe some implementations in greater detail, reference is next made to examples of techniques which may be performed by or using a system for virtual background image generation during video conferences. FIG. 12 is a flowchart of an example of a technique 1200 for generating a virtual background image during a video conference. FIG. 13 is a flowchart of an example of a technique 1300 for outputting video conference key points within a virtual background image. FIG. 14 is a flowchart of an example of a technique 1400 for generating a unified virtual background image for video conference participants.

The technique 1200, the technique 1300, and/or the technique 1400 can be executed using computing devices, such as the systems, hardware, and software described with respect to FIGS. 1-11. The technique 1200, the technique 1300, and/or the technique 1400 can be performed, for example, by executing a machine-readable program or other computer-executable instructions, such as routines, instructions, programs, or other code. The steps, or operations, of the technique 1200, the technique 1300, and/or the technique 1400, or another technique, method, process, or algorithm described in connection with the implementations disclosed herein can be implemented directly in hardware, firmware, software executed by hardware, circuitry, or a combination thereof.

For simplicity of explanation, the technique 1200, the technique 1300, and the technique 1400 are each depicted and described herein as a series of steps or operations. However, the steps or operations of the technique 1200, the technique 1300, and/or the technique 1400 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 12, the technique 1200 for generating a virtual background image during a video conference is shown. At 1202, input associated with a participant of a video conference is obtained. The input is associated with a participant of the video conference. The input corresponds to information usable to generate a virtual background image. For example, the input may be one or more of the inputs 602 through 610 shown in FIG. 6. The input is obtained during a video conference facilitated using conferencing software. The input is obtained by generative artificial intelligence software that is configured to generate a virtual background image based on the input. For example, the input may be obtained directly by the generative artificial intelligence software from a client application at which the input was produced (e.g., typed, by a user of the client application). In some such cases, the input may correspond to a text prompt determined based on text input typed into a GUI at a client device. In another example, the input may be obtained by the generative artificial intelligence software from the conferencing software used to facilitate the video conference, whether as an intermediary (e.g., where the input derived from a client device) or otherwise (e.g., where the input derived from the conferencing software or another software aspect). In some such cases, a real-time transcription of the video conference may be used to determine the input based on a conversational context of the video conference. Other examples are possible.

At 1204, a virtual background image is generated for the participant based on the input. Implementations and examples of generating a virtual background image are described throughout this disclosure. For example, generating the virtual background image for the participant based on the input can include generating the virtual background image according to one or more contextual preferences that identify types of inputs (i.e., types of inputs usable for generating the virtual background image). In another example, generating the virtual background image for the participant based on the input can include generating multiple candidate virtual background images based on the input, in which the multiple candidates may be automatically evaluated and selected without manual user intervention or presented for participant selection via prompt.

At 1206, a selection of the virtual background for use within a video stream of the participant is optionally obtained. For example, one of the participant or a host of the video conference may be enabled to select the virtual background image for use within the video stream of the participant. In another example, where multiple candidate virtual background images are generated, a selection, at a participant device of the participant, of one of the multiple candidate virtual background images as the virtual background image may be enabled. In some implementations, such as where the virtual background image is automatically asserted upon generation or automatically selected from a set of candidates, the selection step may be omitted.

At 1208, the virtual background image is output for use within the video stream of the participant during the video conference. Outputting the virtual background image enables a client application that receives the virtual background image to produce composite images for a video stream using the virtual background image. In some cases, outputting the virtual background image can include automatically asserting the virtual background image as a virtual background of the participant associated with the input independent of manual user action. In some implementations, in connection with or separate from the outputting of the virtual background image for use within the participant video stream, the virtual background image may be stored within a data store for use with one or more future video conferences. In some implementations, the selection of the virtual background image described above may be performed in connection with the outputting of the virtual background image as described herein.

In some implementations, the technique 1200 can include updating the generative artificial intelligence software based on feedback. For example, the feedback may be obtained from a participant device associated with the participant and represent participant satisfaction for the virtual background image generated based on the input. Using this feedback, the generative artificial intelligence software can update its understanding (e.g., via finetuning training of one or more machine learning models used thereby) to learn user preferences over time. In some cases, the feedback may be obtained at one or more times during or after a video conference, within a transcription of the video conference, and/or via a client application.

Referring next to FIG. 13, the technique 1300 for outputting video conference key points within a virtual background image is shown. At 1302, a virtual background image used by a participant during a video conference is obtained. The virtual background image is an initial virtual background image in use with a participant video stream during the video conference. That is, the initial state of the virtual background image refers to a version of the virtual background image prior to the updating thereof to include visual elements as described below. Obtaining the virtual background image may include a client application associated with the participant transmitting the virtual background image to generative artificial intelligence software or the generative artificial intelligence software obtaining it from conferencing software used to facilitate the video conference.

At 1304, one or more key points related to the video conference are determined based on video conference content. The one or more key points are determined by generative artificial intelligence software, for example, via a software agent (e.g., an artificial intelligence companion) of the video conference. The video conference content based on which the one or more key points are determined may, for example, be or include one or more of screen share content shared to the video conference, an agenda of the video conference, body language or speech emphasis of the a participant of the video conference, a digital whiteboard used with the video conference, a transcription of the video conference, content included in the video conference from a physical writing surface exposed to a camera used with the video conference (e.g., a blackboard or physical whiteboard within a lecture hall), or the like. For example, determining the one or more key points related to the video conference may include deriving the one or more key points from screen share content. In another example, determining the one or more key points related to the video conference may include deriving the one or more key points from an agenda. In yet another example, determining the one or more key points related to the video conference may include determining the one or more key points based on one or more of a body language, speech emphasis, or language usage of a speaker during the video conference.

At 1306, the virtual background image is updated to include one or more visual elements representing the one or more key points. Updating the virtual background image to include the one or more visual elements includes determining, by the generative artificial intelligence software, an arrangement of the one or more visual elements based on one or more of a substance of the one or more key points, an order in which the one or more key points are addressed within the video conference, or an inferred importance of the one or more key points. In some cases, updating the virtual background image can include emphasizing a visual element of the one or more visual elements based on one or more of an active discussion of a key point corresponding to the visual element or an inferred importance of the key point. For example, a visual element of the one or more visual elements may be emphasized using one or more font modifiers, such as bolding, italicizing, underlining, or highlighting. In some cases, updating the virtual background image can include removing one or more previously determined visual elements from the virtual background image based on one or more of an expiration of a time threshold or a meeting of a space threshold for the virtual background image.

At 1308, the updated virtual background image is output for use within a video stream of the participant during the video conference. In one particular example, the updated virtual background image is output to a client application to cause the client application to use the updated virtual background image to produce composite images for inclusion within the video stream therefrom, in which the client application corresponds to a same participant who was using the initial virtual background image. In some cases, outputting the updated virtual background image can include outputting the updated virtual background image for use with multiple video streams each corresponding to a different participant during the video conference. In some implementations, the one or more visual elements may be output to a digital whiteboard or document associated with the video conference or to a destination external to the video conference. In some such implementations, the outputting of the one or more visual elements may be simultaneous with the outputting of the updated virtual background image for use within the participant video stream.

In some implementations, the initial virtual background image may include the one or more visual elements and the updating of the virtual background image to include the one or more visual elements may include emphasizing one or more of the visual elements in a new way. For example, items of an agenda of the video conference may be output as visual elements within a virtual background of a host of the video conference, starting at the beginning of the video conference. As each of those agenda items is taken up during the video conference, the visual element corresponding to that agenda item may be emphasized within the virtual background image, for example, via a bounding box and/or one or more font modifiers.

In some implementations, a conversational context of the video conference can be used to further update the virtual background image by emphasizing one or more of the visual elements that are relevant to that conversational context. For example, a conversation occurring during the video conference may be processed using the generative artificial intelligence software or other artificial intelligence available to the video conference to determine that a participant of the video conference is speaking about a topic which was already addressed (e.g., a past agenda item). Based on such a determination, the virtual background image may be further updated to emphasize (or re-emphasize, as the case may be) the subject visual element, for example, via a bounding box and/or one or more font modifiers.

Referring finally to FIG. 14, the technique 1400 for generating a unified virtual background image for multiple video conference participants is shown. At 1402, input associated with a video conference is obtained. The input is associated with the video conference rather than a participant thereof. The input corresponds to information usable to generate a virtual background image. For example, the input may be one or more of the inputs 602 through 610 shown in FIG. 6. The input is obtained during a video conference facilitated using conferencing software. The input is obtained by generative artificial intelligence software that is configured to generate a virtual background image based on the input. For example, the input may be obtained directly by the generative artificial intelligence software from a client application at which the input was produced (e.g., typed, by a user of the client application). In some such cases, the input may correspond to a text prompt determined based on text input typed into a GUI at a client device. In another example, the input may be obtained by the generative artificial intelligence software from the conferencing software used to facilitate the video conference, whether as an intermediary (e.g., where the input derived from a client device) or otherwise (e.g., where the input derived from the conferencing software or another software aspect). In some such cases, a real-time transcription of the video conference may be used to determine the input based on a conversational context of the video conference. In some cases, the input may be determined based on one or more sounds generated by the generative artificial intelligence software and output to participants of the video conference. In some cases, the input may be determined based on content of a video conference breakout room to which devices of a subset of participants of the video conference are connected. Other examples are possible.

At 1404, a virtual background image is generated based on the input. Implementations and examples of generating a virtual background image are described throughout this disclosure. For example, generating the virtual background image based on the input can include generating the virtual background image according to one or more contextual preferences that identify types of inputs (i.e., types of inputs usable for generating the virtual background image). In another example, generating the virtual background image for the participant based on the input can include generating multiple candidate virtual background images based on the input, in which the multiple candidates may be automatically evaluated and selected without manual user intervention or presented for participant selection via prompt.

At 1406, a selection of the virtual background for use within video streams of multiple participants is optionally obtained. For example, a host of the video conference may be enabled to select the virtual background image for use within multiple participant video streams. In another example, where multiple candidate virtual background images are generated, a selection, at a participant device of the host, of one of the multiple candidate virtual background images as the virtual background image may be enabled. Selection of the virtual background image may thus be limited to the client device of the host to avoid undesirable assertions of virtual background images otherwise potentially occurring by other participants. In some implementations, such as where the virtual background image is automatically asserted upon generation or automatically selected from a set of candidates, the selection step may be omitted.

At 1408, the virtual background image is output for use within the video streams of the multiple participants during the video conference. Outputting the virtual background image enables each client application that receives the virtual background image to produce composite images for a video stream using the virtual background image. In some cases, outputting the virtual background image can include automatically asserting the virtual background image as a virtual background of each of multiple participants. In some implementations, in connection with or separate from the outputting of the virtual background image for use within the multiple participant video streams, the virtual background image may be stored within a data store for use with one or more future video conferences. In some implementations, the selection of the virtual background image described above may be performed in connection with the outputting of the virtual background image as described herein.

In some implementations, different virtual background images can be asserted for participant video streams in different breakout rooms of a video conference. For example, various participants may be separated into one of multiple breakout rooms at some point during the video conference. While in the breakout rooms, a virtual background image may be determined for each breakout room and asserted against participant video streams for each participant in the respective breakout rooms. When the participants are caused to rejoin the main meeting space of the video conference, the various breakout room-specific virtual background images may persist within the respective participant video streams.

In some implementations, the generative artificial intelligence software or other AI/ML (e.g., of an artificial intelligence companion accessible to the video conference) may enable participants to generate audio media during the video conference. For example, sounds or music may be generated to serve as music played during the video conference in between presentations, sessions, or the like, or to serve as background music throughout some or all of the video conference. In some cases, the audio media may be generated based on one or more of the inputs usable to generate virtual background images. In some implementations, a virtual background image may be generated or updated according to audio media played during the video conference. In one illustrative and non-limiting example, a virtual background image may be generated or updated to depict a disco ball that flashes along with a cadence of music.

The implementations of this disclosure describe methods, systems, devices, apparatuses, and non-transitory computer readable media for generating virtual background images during video conferences and outputting those generated virtual background images within applicable video conference participant video streams. In some implementations, a method comprises, a non-transitory computer readable medium stores instructions operable to cause one or more processors to perform operations comprising, and/or a system comprises a memory subsystem storing instructions and processing circuitry configured to execute the instructions for: obtaining, by generative artificial intelligence software during a video conference, input associated with a participant of the video conference; generating, by the generative artificial intelligence software, a virtual background image for the participant based on the input; and outputting the virtual background image for use within a video stream of the participant during the video conference.

In some implementations of the method, the non-transitory computer readable medium, and/or the system, obtaining the input associated with the participant of the video conference comprises: determining, using a real-time transcription of the video conference, the input based on a conversational context of the video conference.

In some implementations of the method, the non-transitory computer readable medium, and/or the system, generating the virtual background image for the participant based on the input comprises: generating the virtual background image according to one or more contextual preferences that identify types of inputs.

In some implementations of the method, the non-transitory computer readable medium, and/or the system, generating the virtual background image for the participant based on the input comprises: generating multiple candidate virtual background images based on the input, and outputting the virtual background image for use within the video stream of the participant during the video conference comprises: enabling a selection, at a participant device of the participant, of one of the multiple candidate virtual background images as the virtual background image.

In some implementations of the method, the non-transitory computer readable medium, and/or the system, outputting the virtual background image for use within the video stream of the participant during the video conference comprises: asserting the virtual background image as a virtual background of the participant independent of manual user action.

In some implementations of the method, the non-transitory computer readable medium, and/or the system, the method comprises, the operations comprise, and/or the processing circuitry is configured to execute the instructions for: enabling one of the participant or a host of the video conference to select the virtual background image for use within the video stream of the participant.

In some implementations of the method, the non-transitory computer readable medium, and/or the system, the method comprises, the operations comprise, and/or the processing circuitry is configured to execute the instructions for: storing the virtual background image within a data store for use with one or more future video conferences.

In some implementations of the method, the non-transitory computer readable medium, and/or the system, the method comprises, the operations comprise, and/or the processing circuitry is configured to execute the instructions for: obtaining, by the generative artificial intelligence software during the video conference after the virtual background image is output for use within the video stream of the participant, second input; generating, by the generative artificial intelligence software, a second virtual background image for the participant based on the second input; and outputting the second virtual background image to replace the virtual background image within the video stream of the participant.

In some implementations of the method, the non-transitory computer readable medium, and/or the system, the input corresponds to a text or speech prompt obtained from a participant device of the participant.

In some implementations of the method, the non-transitory computer readable medium, and/or the system, the video conference is implemented by a unified communications as a service software platform.

In some implementations of the method, the non-transitory computer readable medium, and/or the system, the input corresponds to one or more of a location of the participant, a mood of the video conference, speech from one or more participants of the video conference, or content shared to the video conference from a participant device.

In some implementations of the method, the non-transitory computer readable medium, and/or the system, the virtual background image is one of multiple candidate virtual background images generated by the generative artificial intelligence software for selection by the participant or a host of the video conference.

In some implementations of the method, the non-transitory computer readable medium, and/or the system, the virtual background image is saved to a participant device of the participant as a default virtual background for the participant.

In some implementations of the method, the non-transitory computer readable medium, and/or the system, the input corresponds to speech of the participant and obtaining the input comprises: obtaining the speech using a transcription of the video conference.

In some implementations of the method, the non-transitory computer readable medium, and/or the system, the virtual background image is generated according to one or more contextual preferences defined by the participant prior to or during the video conference.

In some implementations of the method, the non-transitory computer readable medium, and/or the system, the virtual background image is selected from amongst multiple candidate virtual background images generated during the video conference based on the input.

In some implementations of the method, the non-transitory computer readable medium, and/or the system, the virtual background image is replaced within the video stream of the participant during the video conference with a second virtual background image generated during the video conference.

In some implementations of the method, the non-transitory computer readable medium, and/or the system, the method comprises, the operations comprise, and/or the processing circuitry is configured to execute the instructions for: updating the generative artificial intelligence software based on feedback, obtained from a participant device associated with the participant, representing participant satisfaction for the virtual background image.

In some implementations, a method comprises, a non-transitory computer readable medium stores instructions operable to cause one or more processors to perform operations comprising, and/or a system comprises a memory subsystem storing instructions and processing circuitry configured to execute the instructions for: determining, by generative artificial intelligence software evaluating content of a video conference, one or more key points related to the video conference; updating, by the generative artificial intelligence software, a virtual background image of a participant of the video conference to include one or more visual elements representing the one or more key points; and outputting the updated virtual background image for use within a video stream of the participant during the video conference.

In some implementations of the method, the non-transitory computer readable medium, and/or the system, the content includes screen share content shared to the video conference, and determining the one or more key points related to the video conference comprises: deriving the one or more key points from the screen share content.

In some implementations of the method, the non-transitory computer readable medium, and/or the system, the content includes an agenda of the video conference, and determining the one or more key points related to the video conference comprises: deriving the one or more key points from the agenda.

In some implementations of the method, the non-transitory computer readable medium, and/or the system, determining the one or more key points related to the video conference comprises: determining the one or more key points based on one or more of a body language, speech emphasis, or language usage of a speaker during the video conference.

In some implementations of the method, the non-transitory computer readable medium, and/or the system, updating the virtual background image of the participant of the video conference to include the one or more visual elements representing the one or more key points comprises: determining, by the generative artificial intelligence software, an arrangement of the one or more visual elements based on one or more of a substance of the one or more key points, an order in which the one or more key points are addressed within the video conference, or an inferred importance of the one or more key points.

In some implementations of the method, the non-transitory computer readable medium, and/or the system, updating the virtual background image of the participant of the video conference to include the one or more visual elements representing the one or more key points comprises: emphasizing a visual element of the one or more visual elements based on one or more of an active discussion of a key point corresponding to the visual element or an inferred importance of the key point.

In some implementations of the method, the non-transitory computer readable medium, and/or the system, updating the virtual background image of the participant of the video conference to include the one or more visual elements representing the one or more key points comprises: removing one or more previously determined visual elements from the virtual background image based on one or more of an expiration of a time threshold or a meeting of a space threshold for the virtual background image.

In some implementations of the method, the non-transitory computer readable medium, and/or the system, outputting the updated virtual background image for use with the video stream of the participant during the video conference comprises: outputting the updated virtual background image for use with multiple video streams each corresponding to a different participant during the video conference.

In some implementations of the method, the non-transitory computer readable medium, and/or the system, the method comprises, the operations comprise, and/or the processing circuitry is configured to execute the instructions for: outputting the one or more visual elements to a whiteboard or document associated with the video conference.

In some implementations of the method, the non-transitory computer readable medium, and/or the system, the method comprises, the operations comprise, and/or the processing circuitry is configured to execute the instructions for: determining, by the generative artificial intelligence software during the video conference, one or more previous key points related to a previous portion of the video conference or of a previous video conference; further updating, by the generative artificial intelligence software, the virtual background image of the participant of the video conference to include one or more second visual elements representing the one or more previous key points; and outputting the further updated virtual background image for use within the video stream of the participant during the video conference.

In some implementations of the method, the non-transitory computer readable medium, and/or the system, determining the one or more key points related to the video conference comprises: determining the one or more key points based on one or more of screen share content shared to the video conference, an agenda of the video conference, or activity of a speaker during the video conference.

In some implementations of the method, the non-transitory computer readable medium, and/or the system, one or more of an arrangement or an emphasis of the one or more visual elements is based on one or more of a substance of the one or more key points, an order in which the one or more key points are addressed within the video conference, an active discussion of the one or more key points, or an inferred importance of the one or more key points.

In some implementations of the method, the non-transitory computer readable medium, and/or the system, the visual background image is updated multiple times during the video conference to change the one or more visual elements.

In some implementations of the method, the non-transitory computer readable medium, and/or the system, the one or more key points are derived based on one or more of screen share content shared to the video conference, an agenda of the video conference, or activity of a speaker during the video conference.

In some implementations of the method, the non-transitory computer readable medium, and/or the system, the one or more visual elements are arranged within the virtual background image based on one or more of a substance of the one or more key points, an order in which the one or more key points are addressed within the video conference, or an inferred importance of the one or more key points.

In some implementations of the method, the non-transitory computer readable medium, and/or the system, a visual element of the one or more visual elements is emphasized using one or more font modifiers.

In some implementations of the method, the non-transitory computer readable medium, and/or the system, the one or more visual elements are output to a source external to the video conference.

In some implementations of the method, the non-transitory computer readable medium, and/or the system, the virtual background image is further updated during the video conference according to input obtained by the generative artificial intelligence software.

In some implementations, a method comprises, a non-transitory computer readable medium stores instructions operable to cause one or more processors to perform operations comprising, and/or a system comprises a memory subsystem storing instructions and processing circuitry configured to execute the instructions for: obtaining, by generative artificial intelligence software, input associated with a video conference; generating, by the generative artificial intelligence software, a virtual background image based on the input; and outputting the virtual background image for use within multiple participant video streams during the video conference.

In some implementations of the method, the non-transitory computer readable medium, and/or the system, obtaining the input associated with the video conference comprises: determining, using a real-time transcription of the video conference, the input based on a conversational context of the video conference.

In some implementations of the method, the non-transitory computer readable medium, and/or the system, obtaining the input associated with the video conference comprises: determining the input based on one or more sounds generated by the generative artificial intelligence software and output to participants of the video conference.

In some implementations of the method, the non-transitory computer readable medium, and/or the system, obtaining the input associated with the video conference comprises: determining the input based on content of a video conference breakout room to which devices of a subset of participants of the video conference are connected.

In some implementations of the method, the non-transitory computer readable medium, and/or the system, generating the virtual background image based on the input comprises: generating the virtual background image according to the one or more contextual preferences identifying types of inputs usable for generating the virtual background image.

In some implementations of the method, the non-transitory computer readable medium, and/or the system, outputting the virtual background image for use within the multiple participant video streams during the video conference comprises: causing some or all participant devices connected to the video conference to produce a participant video stream using the virtual background image.

In some implementations of the method, the non-transitory computer readable medium, and/or the system, outputting the virtual background image for use within the multiple participant video streams during the video conference comprises: asserting the virtual background image a virtual background of some or all participants of the video conference independent of manual user action.

In some implementations of the method, the non-transitory computer readable medium, and/or the system, the method comprises, the operations comprise, and/or the processing circuitry is configured to execute the instructions for: obtaining, from a device associated with a host of the video conference, a selection of the virtual background image, wherein the outputting of the virtual background image for use with the multiple participant video streams during the video conference is based on the selection.

In some implementations of the method, the non-transitory computer readable medium, and/or the system, the input corresponds to a text or speech prompt obtained from a participant device of the participant.

In some implementations of the method, the non-transitory computer readable medium, and/or the system, the video conference is implemented by a unified communications as a service software platform.

In some implementations of the method, the non-transitory computer readable medium, and/or the system, the input corresponds to one or more key points related to the video conference and the virtual background image visually represents the one or more key points.

In some implementations of the method, the non-transitory computer readable medium, and/or the system, the input corresponds to content of a breakout room of the video conference.

In some implementations of the method, the non-transitory computer readable medium, and/or the system, the video conference is a webinar.

In some implementations of the method, the non-transitory computer readable medium, and/or the system, outputting the virtual background image comprises: transmitting the virtual background image to devices running client applications used to connect to the video conference to configure each of the client applications to use the virtual background image within a participant video stream of the multiple participant video streams.

In some implementations of the method, the non-transitory computer readable medium, and/or the system, the input is based on one or more sounds generated by the generative artificial intelligence software and output to participants of the video conference, and the method comprises, the operations comprise, and/or the processing circuitry is configured to execute the instructions for: generating, by the generative artificial intelligence software, the one or more sounds.

In some implementations of the method, the non-transitory computer readable medium, and/or the system, the input is based on a conversational context of the video conference.

In some implementations of the method, the non-transitory computer readable medium, and/or the system, selection of the virtual background image for use with the multiple participant video streams is limited to a host of the video conference.

In some implementations of the method, the non-transitory computer readable medium, and/or the system, the multiple participant video streams correspond to one or both of video streams of non-presenting participants of the video conference or video streams of presenting participants of the video conference.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
determining, by generative artificial intelligence software evaluating content of a video conference, one or more key points related to the video conference;
updating, by the generative artificial intelligence software, a virtual background image of a participant of the video conference to include one or more visual elements representing the one or more key points; and
outputting the updated virtual background image for use within a video stream of the participant during the video conference.

2. The method of claim 1, wherein the content includes screen share content shared to the video conference, and wherein determining the one or more key points related to the video conference comprises:
deriving the one or more key points from the screen share content.

3. The method of claim 1, wherein the content includes an agenda of the video conference, and wherein determining the one or more key points related to the video conference comprises:
deriving the one or more key points from the agenda.

4. The method of claim 1, wherein determining the one or more key points related to the video conference comprises:
determining the one or more key points based on one or more of a body language, speech emphasis, or language usage of a speaker during the video conference.

5. The method of claim 1, wherein updating the virtual background image of the participant of the video conference to include the one or more visual elements representing the one or more key points comprises:
determining, by the generative artificial intelligence software, an arrangement of the one or more visual elements based on one or more of a substance of the one or more key points, an order in which the one or more key points are addressed within the video conference, or an inferred importance of the one or more key points.

6. The method of claim 1, wherein updating the virtual background image of the participant of the video conference to include the one or more visual elements representing the one or more key points comprises:
emphasizing a visual element of the one or more visual elements based on one or more of an active discussion of a key point corresponding to the visual element or an inferred importance of the key point.

7. The method of claim 1, wherein updating the virtual background image of the participant of the video conference to include the one or more visual elements representing the one or more key points comprises:
removing one or more previously determined visual elements from the virtual background image based on one or more of an expiration of a time threshold or a meeting of a space threshold for the virtual background image.

8. The method of claim 1, wherein outputting the updated virtual background image for use with the video stream of the participant during the video conference comprises:
outputting the updated virtual background image for use with multiple video streams each corresponding to a different participant during the video conference.

9. The method of claim 1, comprising:
outputting the one or more visual elements to a whiteboard or document associated with the video conference.

10. The method of claim 1, comprising:
determining, by the generative artificial intelligence software during the video conference, one or more previous key points related to a previous portion of the video conference or of a previous video conference;
further updating, by the generative artificial intelligence software, the virtual background image of the participant of the video conference to include one or more second visual elements representing the one or more previous key points; and
outputting the further updated virtual background image for use within the video stream of the participant during the video conference.

11. A non-transitory computer readable medium storing instructions operable to cause one or more processors to perform operations comprising:
determining, by generative artificial intelligence software evaluating content of a video conference, one or more key points related to the video conference;
updating, by the generative artificial intelligence software, a virtual background image of a participant of the video conference to include one or more visual elements representing the one or more key points; and
outputting the updated virtual background image for use within a video stream of the participant during the video conference.

12. The non-transitory computer readable medium of claim 11, wherein determining the one or more key points related to the video conference comprises:
determining the one or more key points based on one or more of screen share content shared to the video conference, an agenda of the video conference, or activity of a speaker during the video conference.

13. The non-transitory computer readable medium of claim 11, wherein one or more of an arrangement or an emphasis of the one or more visual elements is based on one or more of a substance of the one or more key points, an order in which the one or more key points are addressed within the video conference, an active discussion of the one or more key points, or an inferred importance of the one or more key points.

14. The non-transitory computer readable medium of claim 11, wherein the visual background image is updated multiple times during the video conference to change the one or more visual elements.

15. A system, comprising:
a memory subsystem; and
processing circuitry configured to execute instructions stored in the memory subsystem to:
determine, by generative artificial intelligence software evaluating content of a video conference, one or more key points related to the video conference;
update, by the generative artificial intelligence software, a virtual background image of a participant of the video conference to include one or more visual elements representing the one or more key points; and
output the updated virtual background image for use within a video stream of the participant during the video conference.

16. The system of claim 15, wherein the one or more key points are derived based on one or more of screen share content shared to the video conference, an agenda of the video conference, or activity of a speaker during the video conference.

17. The system of claim 15, wherein the one or more visual elements are arranged within the virtual background image based on one or more of a substance of the one or more key points, an order in which the one or more key points are addressed within the video conference, or an inferred importance of the one or more key points.

18. The system of claim 15, wherein a visual element of the one or more visual elements is emphasized using one or more font modifiers.

19. The system of claim 15, wherein the one or more visual elements are output to a source external to the video conference.

20. The system of claim 15, wherein the virtual background image is further updated during the video conference according to input obtained by the generative artificial intelligence software.
